(19) United States
(12) Patent Application Publication
(10) Pub. No.: US 2009/0315506 A1
(43) Pub. Date: Dec. 24, 2009

(54) Electro - mechanical engine, with self charging system

(76) Inventor: Gary Robichaud, Scarborough (CA)

Correspondence Address: Gary Robichaud, 250 Brenyon Way Suite 1502, Scarborough, ON, M1B-3G3, CA

(21) Appl. No.: 12/381,894

(22) Filed: Mar. 18, 2009

(30) Foreign Application Priority Data
Dec. 10, 2007 (CA) 2, 611, 806

(51) Int. Cl. F03D 3/04; H02K 7/075; F03B 17/04

(52) U.S. Cl. 320/101; 310/20; 415/916

(57) ABSTRACT

Over the course of decades, man has relied on the internal combustion engine to power such things as a car engine.

Although efficient, fossil fuels are needed to power such engines, with a cost, not only to the environment but also for refueling.

By resorting to the electro-mechanical piston engine to power such things as a car, you eliminate the need to burn fossil fuels which result in global warming and green house gases, which are currently destroying our environment.

With the onboard charging system, you have the ability to charge the batteries while on the go, thus eliminating the need for refueling.

This inventive process relates to an electromechanical piston engine and charging system.

Over the course of more than a century , man has relied on the internal combustion engine to produce the forces needed to power such things as a car engine.

Proven effective, but at what cost?

The internal combustion engine is neither fuel efficient, cost effective, or environmentally friendly because of the fossil fuels needed to power its internal workings, thus creating a hazardous environment by expelling burnt fossil fuels, toxins and green house gasses into the environment, where-by, climate change can and does happen and can affect everyone.

I have found that power can be achieved by natural forces to overcome these obstacles.

To accomplish this, one would, by using wind power and electro-mechanical forces, achieve the force needed to power a car engine.

Although we have moved forward and advanced insofar as solar, hydrogen hybrids, and electric power cars, all of which, do, come with limitations.

Some of these limitations are, being of distance, recharging, refueling and affordability.

With the trading off of gas, and adapting to an electromechanical powered engine and with the use of the onboard charging system one would eliminate the need of burning fossil fuels which is the number 1 contributing factor in air pollution and also would eliminate the need to recharge the batteries from their local utilities, where-by, the local utilities and or generating plants would not have to supply power to regenerate power to the batteries.

Fact: Batteries do not create energy; they only store it, to be used when needed.
By resorting to this inventive process one would overcome many of these disadvantages.

Some advantages for resorting to this invention;
No pollutants
No refueling
Batteries always charged, without the need to plug into a typical home outlet.
Wind tubes help eliminate wind resistance
No engine idle
Wind exhausts out of the back of vehicle instead of toxins.
Alternative engine block

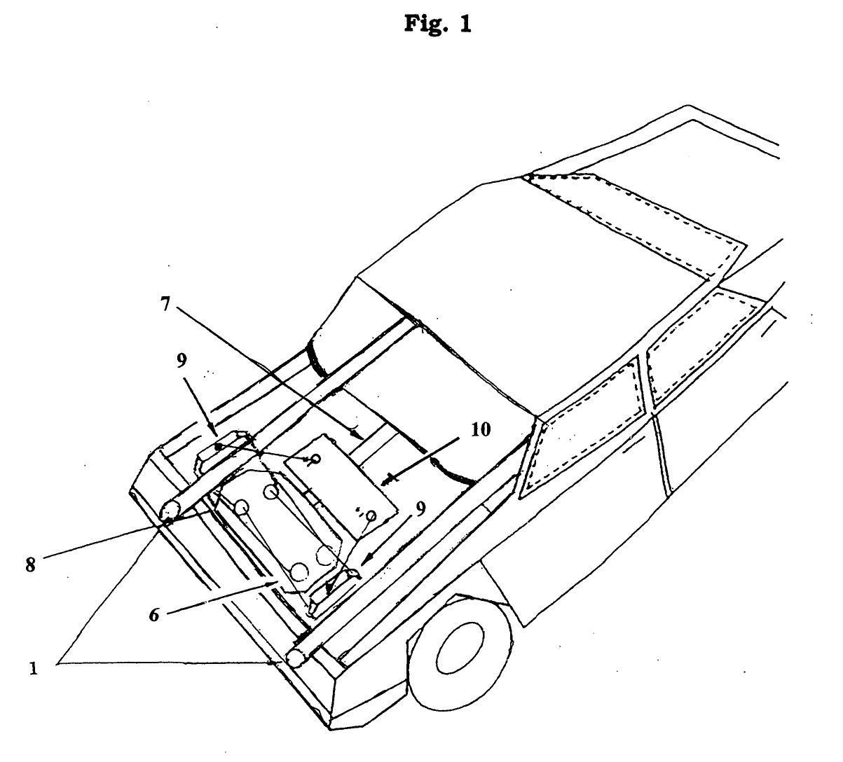

The process needed to power such a vehicle , is first to harness the power generated from the wind as it passes through the wind tubes FIG. 1-(1)

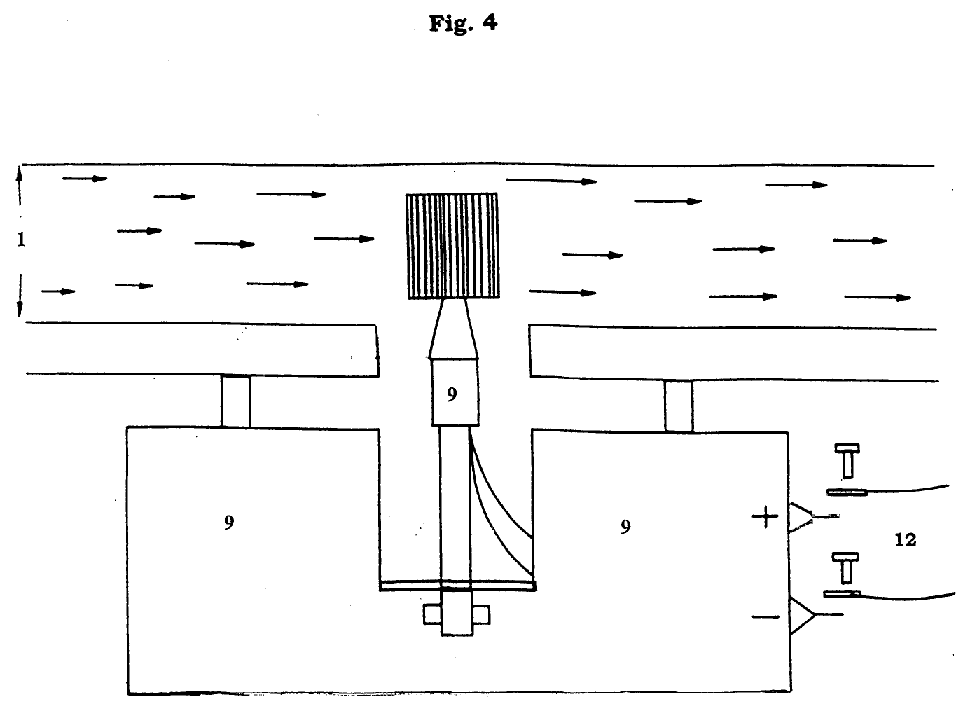

As the wind passes through the wind tubes, a combined computer, charging and impeller system FIG. 1 (9) FIG. 4 (9) is driven from the force of the wind, as it passes through the wind tubes FIG. 1 (1) FIG. 4 (1).

The computer controlled impeller and charging system FIG. 4 (9), now sends a charge to the battery bank FIG. 1(10) on an as needed basses, enabling the battery bank to remain fully charged at all times.

With the charging system and battery bank being the life blood of the system and operational, the computer can now draw it's energy from the battery bank, (10) to control all the additional systems needed to operate the vehicle FIG. 1(9) FIG. 4 (9)

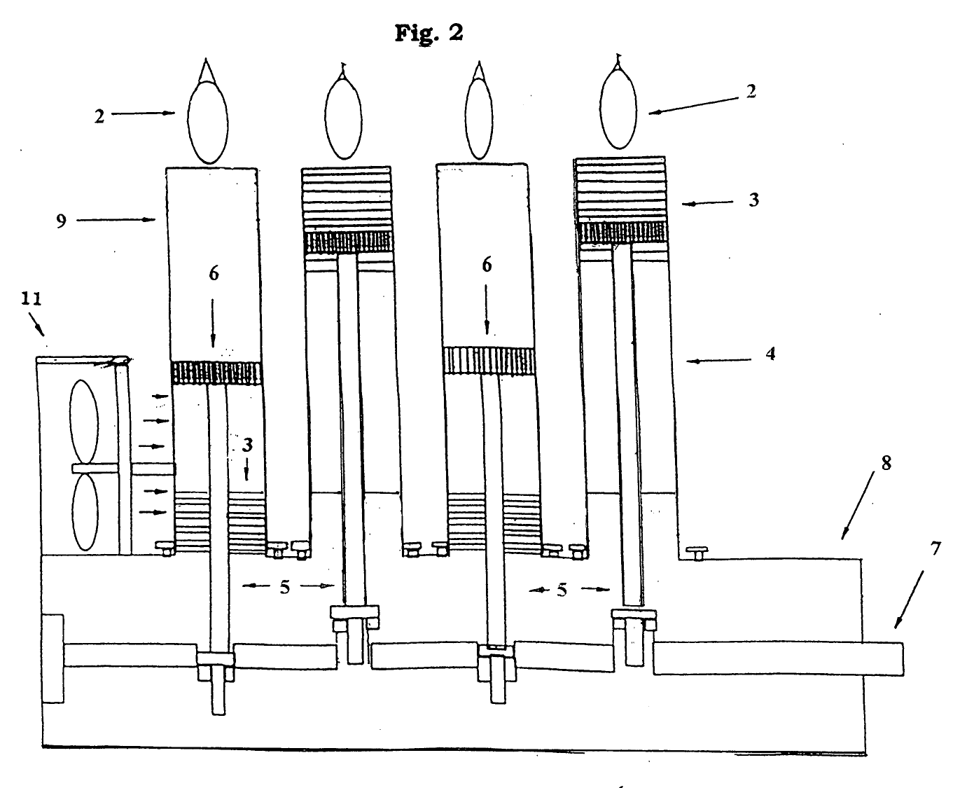

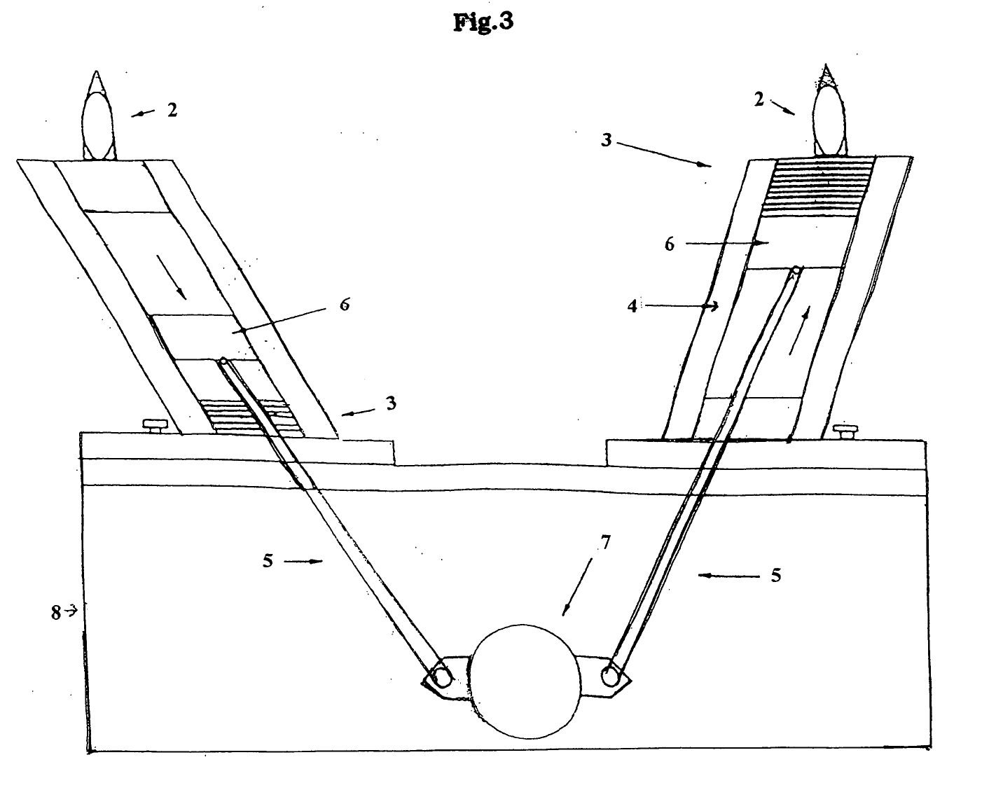

The engine block housing (8) consists of non conductive block incasing the crankshaft FIG. 2-3 (7) and piston rods FIG. 2-3 (5) which is now ready to accept the insulated cylinder heads FIGS. 2-3 (4) either strait up formation or the optional V configuration.

With the engine block FIG. 2-3 (8) and external cylinder heads now in place, and having a coil FIG. 2-3 (2) both top and bottom, with the top coil in center position and the bottom coil encasing the bottom of the cylinder , when energized would draw a piston FIGS. 2-3 (6) from a dormant position, drive said piston, into it's electromechanical field thus creating the required force needed to turn a crankshaft.

With the engine being driven from an electrical current, sent by the battery bank and computer to the piston coil , and having an accelerator pedal to control the amount of current sent to the coils, one could in fact, control the acceleration of the vehicle.

With the addition of say, a cryostat or potentiometer, one would be able to increase the horse power and also be able to use these additions as a sort of a cruise control by regulating the voltage sent to the individual coils.

The cooling of the engine if needed is attained from tapping into the wind tubes or by the fan damper system FIG. 2 (11).

### BRIEF DESCRIPTION OF THE PREFERRED EMBODIMENT

FIG. 1: Is an overall view of an example of how the embodiment locations of this system could work, which are inclusive of the combined impeller/charging and computer systems (9), the engine block (8) and wind tubes (1) and how they would be set up in order to make the system work, with the wind tubes (1) being placed at bumper level.

This drawing also depicts an overhead view of the locations of the impellers (9) the battery bank (10) the computer/charging pack (9) the engine block (8) as well as the piston locations (6) and crankshaft (7).

FIG. 2: Depicts a side view of the piston engine in a vertical configuration, along with the energized electrical fields (3) created by the electrical coils (2), enabling the pistons (6) to be drawn into an up and down cycle within there insulated cylinders FIGS. 2-3 (4), enabling the piston rods (5) to drive the crankshaft (7) that is housed within the engine block (8).

FIG. 3: Depicts a front view of the engine assembly in a V shaped configuration thus taking up less engine compartment.

This drawing also shows the other components required as in FIG. 2, such as the pistons (6) and piston rods (5), the electrical coils (2) and the magnetic fields (3) both top and bottom when they are energized.

Additional elements as shown being the engine block (8), insulated cylinder heads (4) and crankshaft (7

FIG. 4: Depicts a side view of the combined charging/computer/impeller and solenoid system and its components.

The impeller/generator (9) which is placed within the wind tubes (1) and being part of the complete charging system is shown in the energized position which is being controlled by the onboard computer system (9), thus allowing for the charging system (9) to charge the batteries directly via the charging cables (12) on a as needed basis.

### BACKGROUND OF THE INVENTION

This invention relates to a way of powering a non polluting, fuel free vehicle by means of creating an electromechanical field to which a metallic disc piston could be drawn into said field.

With the pistons being drawn in a upward and downward movement caused by the electromechanical forces as in a traditional internal combustion engine do, the pistons and connecting piston rods could in fact turn a crankshaft which in turn would power a driveshaft enabling the vehicle to move.

The lifeblood of this engine is the onboard combined charging/impeller/generator and computer systems. The charging system consisting of a computer, a computer controlled impeller/generator, and a charger.

The computer system which now draws its power from the fully charged battery system can now control the firing sequence of the pistons and all of the other many functions of the vehicle.

1/Field of the Invention

This invention relates to a car engine that requires no fuel but obtains its power from within by harnessing natural forces to create an a electrical field, the electromechanical forces generated from a coil and a wind powered charging system.

2/Description of the Relevant Art

Usually automobiles are powered by an internal combustion engine. Effective, but not without a cost. That cost being the burning of fossil fuels such as gasoline which emit pollutants into the atmosphere such as CO/2, plus the additional cost of replacing the burnt fuel.

### SUMMARY OF THE INVENTION

The purpose of this invention is a way to power a car that requires no fossil fuels but generates its own power from within.

The embodiments of the invention in which an exclusive property or privilege is claimed and being sought are defined as follows:

1.) Piston: as described and represented in the specifications and drawings (A, B &C) and consisting of a metallic disc able to accept the electro-mechanical force created by energizing an electrical coil, top and bottom, and being synchronized by the onboard computer to facilitate it's on and off operation.
Said piston having an insulated piston rod and crankcase attached to itself and the crankshaft.

2.) A battery bank consisting, of and represented in, drawing (A), comprising of a series of conventional lithium-ion batteries, wired in series, as to support the needs of the vehicle and it's functions.

3.) Wind tubes, as shown and described in drawing (A) (FIG. 1.a.) and drawing (D), having a metal composition and formed to be installed under the car chaises for receiving the winds forces at bumper level to allow for the passage of the wind through the wind tube chamber of the vehicle.

4.) A preset computer as described in claim (1) to control a programmed, on/off firing system, for the pistons, as described and claimed in claim (1). Where-by, additional functions would be included, but not limited to, activation of the impeller and charging systems, as well as the heating and cooling systems.

5.) Impeller, as illustrated and represented by drawing (D), having fins or an anemometer to receive and employ the winds force as it passes through the wind tubes and to be placed inside the wind tubes, as described in claim (3) and controlled by the computer as described in claim (4) to be driven by the winds force's on a as needed bases.

6.) Charging system being part of the wind tubes, computer and impeller systems, as claimed in claim (3)-(4) and (5) and being controlled by the computer system, as it monitors the needs of the battery system.

7.) Solenoid, as shown in drawing (D) to energize and elevate the impeller into the wind tube for charging purposes.
Once charging has been completed said solenoid reenergizes and allows the impeller to drop out of the wind chamber.
